(19) United States
(12) Patent Application Publication
(10) Pub. No.: US 2014/0264186 A1
(43) Pub. Date: Sep. 18, 2014

(54) Ion producing and infrared emitting composition

(71) Applicants: Douglas Spatz, Downingtown, PA (US); Dan DeLaRosa, Coral Springs, FL (US)

(72) Inventors: Douglas Spatz, Downingtown, PA (US); Dan DeLaRosa, Coral Springs, FL (US)

(21) Appl. No.: 13/999,638

(22) Filed: Mar. 14, 2014

Related U.S. Application Data
(60) Provisional application No. 61/852,456, filed on Mar. 15, 2013.

(51) Int. Cl. C09K 11/02

(52) U.S. Cl. CPC C09K 11/025
USPC 252/506; 252/518.1; 252/512; 252/513; 252/514; 252/515; 252/521.6; 252/521.4; 252/521.3; 252/519.4; 252/520.3; 252/519.2; 252/519.33

(57) ABSTRACT

The present invention provides for a natural, non-toxic, environmentally friendly, “green” mineral based composition that produces ions and emits far infrared heat and the composition comprises tourmaline microcrystals and at least one activating element.

### RELATED APPLICATION:

This application is related to U.S. Provisional Application Ser. No. 61/852,456 filed on Mar. 15, 2013 entitled “An Ion Producing and Infrared Emitting Composition”.

### BACKGROUND OF THE INVENTION

1. Field of the Invention

An ion producing and far infrared emitting composition comprised of natural, non-toxic, environmentally friendly, “green” minerals that are admixed together produce a continuous flow of air ions when stimulated by pressure and/or temperature changes. The composition also absorbs heat and converts it into far infrared rays that have wavelengths of eight to fifteen microns.

The composition can be added, incorporated, embedded and/or coated to a plurality of other materials and products. The composition creates a small electric field consisting primarily of electrons that ionize liquid and gas molecules entering the field to create a continuous flow of ions. The electrostatic discharge is created through the principal catalysts piezoelectric and pyroelectric properties.

The composition is antimicrobial and the related method of manufacture comprises admixing tourmaline microcrystals with at least one activating element. The composition may then be added, incorporated, embedded and/or coated directly product or added, incorporated, embedded and/or coated onto polymers which can be added to product.

2. Description of the Related Art

There are various patents covering the production of anions and/or far infrared heat. The present invention provides for a natural, non-toxic, environmentally friendly, “green” mineral based composition comprising tourmaline microcrystals and at least one activating element.

### SUMMARY OF THE INVENTION

In one embodiment, the present invention relates to an ion producing and far infrared emitting composition comprising: tourmaline microcrystals and at least one activating element. In another embodiment, the composition produces anions. In a further embodiment, the composition produces cations.

In another embodiment, the tourmaline microcrystals are selected from a group consisting essentially of synthetic tourmaline mincrocrystals, and from the mineral groups comprising buergerite, chromdravite, dravite, elbaite, feruvite, foitite, liddicoatite, olenite, povondraite, schorl, uvite, and mixtures thereof.

In yet another embodiment, the activating element selected from the group consisting essentially of aluminum, antimony, apatite, arsenic, barium, beryllium, boron, bromine, cadmium, calcium, carbon, cesium, chlorine, chromium, cobalt, copper, fluorine, gold, hydrogen, iodine, iron, lithium, lead, magnesium, manganese, mercury, molybdenum, nickel, nitrogen, oxygen, palladium, phosphorus, platinum, potassium, radium, selenium, silicon, silver, silver sulfate, silver nitrate, silver sulfidiazene, sodium, strontium, sulfur, tellurium, tin, titanium, tungsten, uranium, vanadium zinc, and zirconium; and mixtures thereof.

In still another embodiment, the tourmaline microcrystals have a particle size in the range of submicron to about forty-three microns. In still yet another embodiment, the activating element has a particle size in the range of submicron to about forty-three microns.

In a further embodiment, the composition may be incorporated into a product by a method selected from a group consisting of embedding, coating, admixing, layering and combinations thereof.

In another further embodiment, the product is a textile and the textile is selected from a group comprising cotton, silk, acrylics, polyesters, nylons, viscose, rayon, wools, lycra, spandex, synthetics, natural fibers, rugs, carpets, and mixtures and combinations thereof. The composition may be adhered to the textiles with bonding agents or maybe coated onto polymers which are incorporated into the textiles during the weaving process. The composition coated polymers may be used to create yarn for textiles that can be used to create clothing, sheets, blankets, drapes, and pet beds.

In yet a further embodiment, the product is a skin care and cosmetic product and the composition is incorporated into products that are selected from a group comprising skin care and cosmetic creams, lotions, gels, lipsticks, make up, astringent, balms, shampoos, conditioners, soaps, and combinations thereof. In still a further embodiment, the composition further comprises a drug to formulate a pharmaceutical, cosmeceutical and OTC skin care product.

In still yet a further embodiment, the product is selected from a group comprising paints, varnishes, paint removers, primers and combinations thereof.

In another embodiment, the products are mechanic parts and the composition is coated onto said mechanic parts; said parts are selected from a group comprising engines, motors, carburetors, and other related products.

In yet another embodiment, the products are medical, animal, dental, vet nary, and agricultural products.

In still another embodiment, the products are athletic gear, equipment, sporting goods and apparel.

In still yet another embodiment, the products are water and air filters, food preparation and storage.

In a further embodiment, the composition is incorporated into at least one polymer by a method selected from embedding, coating, bonding, admixing and combinations thereof.

In another embodiment, the method for manufacturing a formulation that produces ions and emits far infrared, and the method comprises: admixing tourmaline microcrystals and at least one activating element.

In a further embodiment, the method of further comprises incorporating the formulation onto a product. In another further embodiment, he method further comprises incorporating said formulation into a polymer and then incorporating said polymer with said formulation into a product.

In yet another further embodiment, the formulation comprising tourmaline microcrystals and at least one activating element wherein said formulation that produces and emits ions.

In still another further embodiment, the formulation comprising tourmaline microcrystals and at least one activating element wherein said formulation that produces and emits far infrared.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

The composition and/or formulation of the present invention may be used in a plurality of applications and products. The following are examples of products and applications for the presently claimed invention:

Agricultural products—tests conducted plants with plant pots made with the composition of the present invention and another group with same composition pieces dispersed differently on top of and/or partially into the soil to verify changes in growth rate compared to a control group. Results demonstrated roughly a thirty percent plus increase in height, the number of leaves and flowers that bloomed a week before the control. Tests also demonstrated water usage decreased by 25% when using plant pots containing the composition.

Apparel—AATCC TEST METHOD 100-1993 Bonding agent AM500 with 0.25% of the composition produced a 99.99% reduction in Staphylococcus aureus within 24 hours. Epidemiological studies demonstrated pain relief from arthritis, athletic injuries, etc., and also produced greater flexibility of limbs.

Toothbrushes—“A Clinical Study to Evaluate the Effectiveness of an Iontophoretic Toothbrush in the Removal of Dental Plaque” using a battery operated or electrically powered ion toothbrush producing anions from the stem had the following clinical results:
A 36.17% reduction in plaque from baseline to month six, compared to only 18.56% for the control group.
Improvement in gingival health was 51.87% for the test group and 30.18% for the control group.
A reduction in sensitivity after six weeks was shown to be 60.6% and in the placebo group 25.4%.
50.1% of the initially sensitive teeth had lost all sensitivity after six weeks.
Collins found an 87.5% decrease in hypersensitivity in his active group and a 22.8% decrease in the control group.

The composition of the present invention can be embedded directly into the toothbrush bristles.

Sports wraps—The thermographic photos were taken of foam patches containing the composition. It is approximately 3″×4″ in size and 62.5 mm or 1/16″ thick. The patch was fastened to an easel and left hanging for three minutes in order to ensure it adjusted to the room temperature of its surroundings. The sample was then photographed to show the FIR distribution as it reflected the heat generated by the sample. The average temperature produced by the sample was 21.5° C.

Next a hand was placed upon the sample for a two minute period and more thermographic images were taken. The results demonstrated the composition containing pad reacts to contact with the body. The increase in temperature averaged 25.7° C.

This reaction creates a deep thermal effect within the layers of the body tissue, providing warmth as the healing process begins. The far infrared energy force promotes healing through an increase in the white blood count. The patches have the ability to relieve pain, muscle aches, strains, sprains, swelling, inflammation, joint pain and more.

Engines—configuring various components with the composition, conducted numerous tests in cars and trucks and verified an increase in power with a reduction in fuel consumption. Fuel Economy Testing of a 2010 Chevrolet Tahoe was conducted on an authorized testing facility dynamometer. The results showed an increase in mpg with a decrease in emissions.

Highway tests of cars and trucks resulted in mpg improvements ranging from 20% to greater than 50%. Trucks were operating at 1500 rpm less to maintain previous speeds.

Skin Care—Epidemiological tests include the use of patches containing the composition on the gray skin of a person with very poor blood pressure. After thirty seconds the skin turned a health pink color. Numerous users of soap containing the composition claimed their skin felt softer. Numerous users with acne problems found their conditions cleared up after one usage. An infant suffering from dermatitis was washed with the same soap and essentially eliminated the outbreaks. The parents stated this application worked far better than any pharmaceutical remedy. People with skin wrinkles and age spots also claimed their wrinkles declined and age spots cleared up. We do have photos showing before and after results.

Air Filters—House air filters were coated with the composition using a textile coating. Air smelled much cleaner and far less dust collected in the houses where the tests were conducted.

Water Filters—The composition also alters the pH, a physical characteristic well known about the principle catalyst. Experiments include filling water glasses with Chlorine. Polymers impregnated with the composition were dropped in one and the other glass that contained water with chlorine was stirred. In approximately five minutes the chlorine water that was stirred lost all its color and chlorine smell. The other chlorine water required an extra ten to 13 minutes before it reached the clean state.

Food Preparation and Storage—Test conducted by commercial ionizers were able to preserve food for longer periods of time when subjected to a negative ion atmosphere. The natural antimicrobial nature of the composition will prevent mold growth of Aspergillus niger, the most prevalent mold problem in the US. CDC writes Aspergillus is a common fungus that can be found in indoor and outdoor environments. Most people breathe in Aspergillus spores every day without being affected. Aspergillosis is a disease caused by this fungus and usually occurs in people with lung diseases or weakened immune systems. The spectrum of illness includes allergic reactions, lung infections, and infections in other organs. Fungal infections pose an increasing threat to public health for several reasons..

Veterinary and Medical Products—Equine and canine wraps, pads, clothes with the composition producing Far Infrared Rays caused fluid buildups in joints to completely subside in less than 24 hours, sore and stiff legs to loosen up, painful hooves limiting movement to subside and cause animals to act normally again within minutes and elderly animals suffering with arthritis from old wounds or age move significantly better and often without any lameness.

Relief from pain, swelling, inflammation was reported by over 90% of people testing EyeOn products. One child with a fracture had his cast covered with a wrap containing the composition of the present invention and showed improvements in exactly one half of the expected time. An adult with a torn Achilles tendon that was repaired surgically and covered with the composition infused wrap showed improvements in two months.

Pet Beds—Composition coatings producing anions have an odor eating effect. Animals given the chance to select where to rest do select the spread (containing the composition) far greater than the majority of the time. Pets suffering from arthritis showed a tremendous improvement in lameness after sleeping on the pet beds containing the composition.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. An ion producing and far infrared emitting composition comprising: tourmaline microcrystals and at least one activating element.

2. The composition of claim 1 wherein said tourmaline microcrystals are selected from a group consisting essentially of synthetic tourmaline mincrocrystals, and from the mineral groups comprising buergerite, chromdravite, dravite, elbaite, feruvite, foitite, liddicoatite, olenite, povondraite, schorl, uvite, and mixtures thereof.

3. The composition of claim 1 wherein said activating element selected from the group consisting essentially of aluminum, antimony, apatite, arsenic, barium, beryllium, boron, bromine, cadmium, calcium, carbon, cesium, chlorine, chromium, cobalt, copper, fluorine, gold, hydrogen, iodine, iron, lithium, lead, magnesium, manganese, mercury, molybdenum, nickel, nitrogen, oxygen, palladium, phosphorus, platinum, potassium, radium, selenium, silicon, silver, silver sulfate, silver nitrate, silver sulfidiazene, sodium, strontium, sulfur, tellurium, tin, titanium, tungsten, uranium, vanadium zinc, and zirconium; and mixtures thereof.

4. The composition of claim 1 wherein said tourmaline microcrystals has a particle size in the range of submicron to about forty-three microns.

5. The composition of claim 1 wherein said activating element has a particle size in the range of submicron to about forty-three microns.

6. The composition of claim 1 wherein said composition may be incorporated into a product by a method selected from a group consisting of embedding, coating, admixing, layering and combinations thereof.

7. The composition of claim 6 wherein said product is a textile and said textile is selected from a group comprising cotton, silk, acrylics, polyesters, nylons, viscose, rayon, wools, lycra, spandex, synthetics, natural fibers, rugs, carpets, and mixtures and combinations thereof.

8. The combination of claim 6 wherein said product is a skin care and cosmetic product and said composition is incorporated into products that are selected from a group comprising skin care and cosmetic creams, lotions, gels, lipsticks, make up, astringent, balms, shampoos, conditioners, soaps, and combinations thereof.

9. The composition of claim 8 further comprising a drug to formulate a pharmaceutical, cosmeceutical and OTC skin care product.

10. The composition of claim 6 wherein said product is selected from a group comprising paints, varnishes, paint removers, primers and combinations thereof.

11. The composition of claim 6 wherein said product are mechanic parts and said composition is coated onto said mechanic parts; said parts are selected from a group comprising engines, motors, carburetors, and other related products.

12. The composition of claim 6 wherein said products are medical, animal, dental, vet nary, and agricultural products.

13. The composition of claim 6 wherein said products are athletic gear, equipment, sporting goods and apparel.

14. The composition of claim 6 wherein said products are water and air filters, food preparation and storage.

15. The composition of claim 1 wherein composition is incorporated into at least one polymer by a method selected from embedding, coating, bonding, admixing and combinations thereof.

16. A method for manufacturing a formulation that produces ions and emits far infrared, said method comprising: admixing tourmaline microcrystals and at least one activating element.

17. The method of claim 16 further comprising incorporating said formulation onto a product.

18. The method of claim 17 further comprising incorporating said formulation into a polymer and then incorporating said polymer with said formulation into a product.

19. A formulation comprising tourmaline microcrystals and at least one activating element wherein said formulation that produces and emits ions.

20. A formulation comprising tourmaline microcrystals and at least one activating element wherein said formulation that produces and emits far infrared.
